(19) United States
(12) Patent Application Publication
(10) Pub. No.: US 2026/0109418 A1
(43) Pub. Date: Apr. 23, 2026

(54) MASTER LINK END FOR MASTER LINK ASSEMBLY AND RELATED METHODS

(71) Applicant: Caterpillar Inc., Peoria, IL (US)

(72) Inventors: Stan R. PARROTT, Chillicothe, IL (US); Jason L. SEBRIGHT, Chillicothe, IL (US)

(73) Assignee: Caterpillar Inc., Peoria, IL (US)

(21) Appl. No.: 18/924,517

(22) Filed: Oct. 23, 2024

(51) Int. Cl. B62D 55/21

(52) U.S. Cl. CPC B62D 55/213

(57) ABSTRACT

A master link end of a master link assembly includes a length, a thickness, and a mating surface. The mating surface includes a first ramp, a second ramp, a third ramp, and a tooth formed by and between the first ramp and the second ramp. The mating surface may include a concave surface between the second ramp and the third ramp. The tooth includes a convex crown formed by a plurality of facets. Each facet of the plurality of facets shares a common edge with one or more facets of the plurality of facets. The common edges define or approximately define an arc of a circle.

### TECHNICAL FIELD

The present disclosure relates generally to a master link for a chain of a track undercarriage of a machine, and more particularly, to aspects of mating surfaces of master link ends of a master link.

### BACKGROUND

A track machine utilizes chains entrained about a sprocket, rollers, one or more idlers, and a track roller frame. A motor or an engine drives the sprocket, which engages bushings of the chain to move the chain around the track roller frame, thereby propelling the machine in the desired direction.

Typically, the chain includes a master link joint that allows assembly and disassembly of the chain by coupling the ends of the chain at the master link joint. While a “master link joint” is available in many forms, one prevalent design includes two “master links” arranged parallel to each other and disposed on either side of the chain. Each master link includes two “half links,” including a “first half link” or “first master link end,” and a “second half link” or “second master link end.” The first master link end may include a mating surface corresponding to a mating surface of the second master link end. A pin and bushing assembly couples the two parallel master links together. The bushing also engages the sprocket to drive the chain. Threaded fasteners couple a shoe to the master links, and couple the two master link ends together such that the respective mating surfaces of the master link ends engage with one another.

U.S. Patent No. 9,926,024, (“the ’024 patent”), discloses a master link in the form of a first half link and a second half link. For example, the first half link includes a mating abutment surface that engages a mating abutment surface of the second half link. The mating abutment surfaces include a first ramp that meets a second offset ramp at a junction or root. The complex geometries of mating abutment surfaces may be difficult to design in view of the high loads typically experienced by master links during operation. Further, the complex geometries may be particularly burdensome to manufacture, often requiring advanced machinery, specially-trained personnel to operate the advanced machinery, and/or significant amounts of manufacturing time.

The present disclosure may solve one or more of the problems set forth above and/or other problems in the art. The scope of the current disclosure, however, is defined by the attached claims, and not by the ability to solve any specific problem.

### SUMMARY

In one aspect, a master link end of a master link assembly may include a length, a thickness, and a mating surface. The mating surface may include a first ramp, a second ramp, a third ramp and a tooth formed by and between the first ramp and the second ramp. The mating surface may include a concave surface between the second ramp and the third ramp. The tooth may include a convex crown formed by a plurality of facets. Each facet of the plurality of facets may share a common edge with one or more facets of the plurality of facets. The common edges may define or approximately define an arc of a circle.

In another aspect, a method of manufacturing a master link end of a master link assembly may include (i) forging an approximate shape of a master link end, (ii) machining a tooth formed by and between a first ramp and a second ramp, and machining a third ramp, (iii) machining a plurality of facets to form a convex crown on the tooth. A width of each facet of the plurality of facets may be tangent or approximately tangent to a circle.

In yet another aspect, a master link assembly may include a first master link end having a first mating surface and a second master link end having a second mating surface. The first mating surface and the second mating surface may each include a tooth and a substantially continuous concave surface. The tooth may include a convex crown formed by a plurality of facets. Each facet of the plurality of facets may share a common edge with one or more facets of the plurality of facets. Further, each facet of the plurality of facets may include a width. The width of each facet of the plurality of facets may be the same or approximately the same. The first mating surface may be configured to engage the second mating surface such that the tooth of the first mating surface is received within the substantially continuous concave surface of the second mating surface. The tooth of the second mating surface may be received within the substantially continuous concave surface of the first mating surface.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a perspective view of an exemplary machine including an exemplary master link assembly.

FIG. 2 depicts a partial exploded view of the master link assembly.

FIG. 3 depicts a side view of a master link end of the master link assembly.

FIG. 4 depicts an exemplary flow chart for an exemplary method of manufacturing a master link end of the master link assembly.

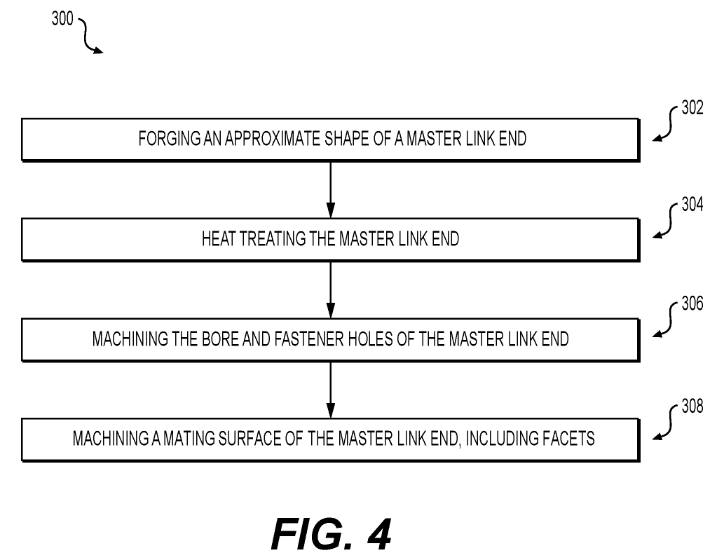

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

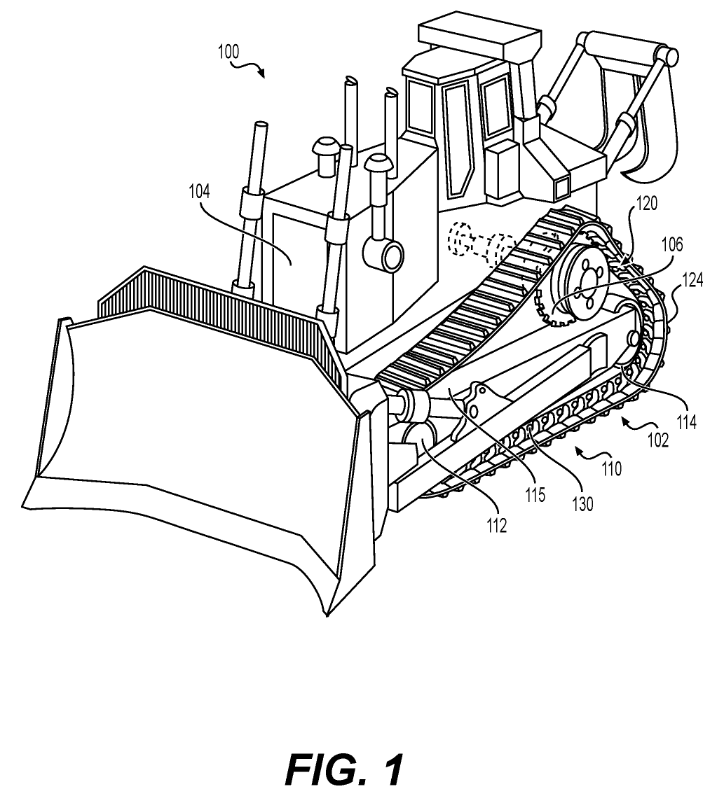

FIG. 1 depicts an exemplary tractor (“machine”) 100 configured to be used in the farming, construction, mining, power generation, and other like industries. Machine 100 is equipped with a track undercarriage 102 that can accommodate the master link assembly as described herein. A power source 104, such as combustion engine or one or more electric motors, powers machine 100. Power source 104 drives a sprocket 106, which engages bushings 130 of a chain 110. Chain 110 is formed from a plurality of links in which adjacent links are connected together via a pin and bushing assembly 116. Sprocket 106 rotates and cycles chain 110 about spaced apart idlers 112, 114. A track roller frame 115 may connect idlers 112, 114 to one another. A shoe 124 couples side-by-side links of chain 110 together. Machine 100 includes a master link assembly 120 that couples a first end of chain 110 to a second end of chain 110. Although machine 100 is described herein as being a tractor, it should be understood that machine 100 is not limited to tractors. For example, machine 100 may be any mobile machine using a track to propel the machine, such as an excavator, bulldozer, skid-steer loader, dragline, rope shovel, etc.

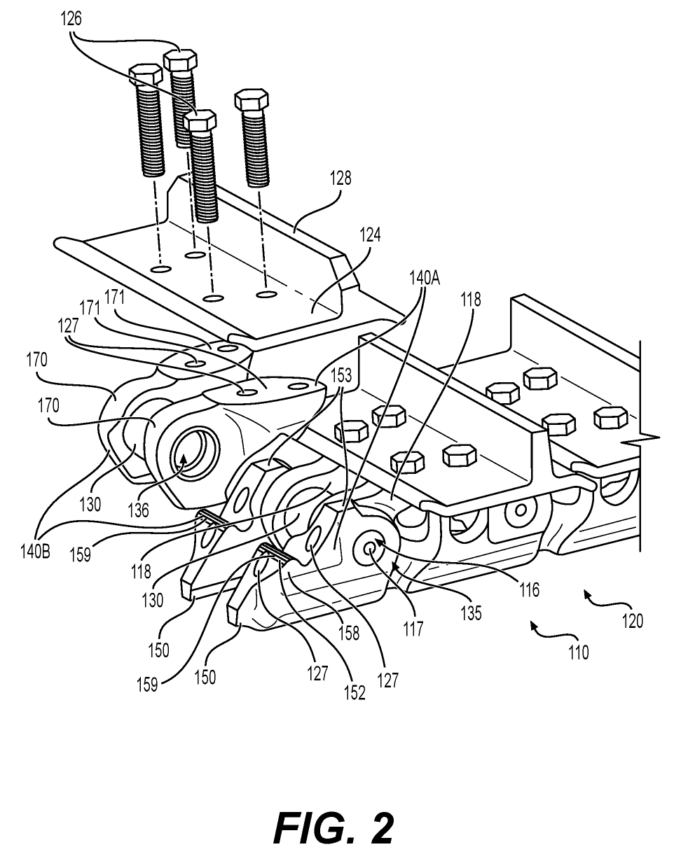

FIG. 2 depicts a partial exploded view of an exemplary master link assembly 120 of machine 100. In particular, FIG. 2 depicts a first master link 140A and a second master link 140B. First master link 140A is disposed side-by-side with second master link 140B along a length of chain 110. First master link 140A and second master link 140B each include a first master link end 150 and a second master link end 170. First master link ends 150 includes a bore 135 configured to accommodate a pin 117 of pin and bushing assembly 116, and second master link ends 170 includes a bore 136 configured to accommodate a bushing 130 of pin and bushing assembly 116. Sprocket 106 may be configured to engage one or more of bushings 130 while driving chain 110.

In the exemplary embodiment shown in FIG. 2, master link assembly 120 may include offset links 140A and 140B, such that respective bores 135 of first master link ends 150 may be spaced further apart than respective bores 136 of second master link ends 170. In such an offset link configuration, first master link ends 150 may be referred to as a pin ends, with the bores 135 of first master link ends 150 configured to receive a pin 117 therein. Second master link ends 170 may be referred to as a bushing ends such that a bushing 130 may be aligned with bores 136 (e.g., generally coaxial with central axes of bores 135) and couple second master link ends 170 to each other. According to other aspects of the present disclosure, instead of an offset link, first master link ends 150 may be coupled to second master link ends 170 to form a straight link where respective bores 135 of first master link ends 150 and bores 136 of second master link ends 170 are spaced the same distance apart from one another.

Master link assembly 120 further includes a shoe 124 coupled to the first master link ends 150 and second master link ends 170 with fasteners 126 (e.g., a threaded fastener such as a bolt 126). Shoe 124 may include corresponding fastener holes, each configured to receive one of fasteners 126. Shoe 124 via fasteners 126 may couple first master link ends 150 to second master link ends 170 and couple first master link 140A and second master link 140B. For example, shoe 124 may be fastened to a shoe surface 171 of second master link ends 170. Shoe surface 171 may be a planar surface. First master link ends 150 may also include a shoe surface 153 that may be a planar surface. Shoe surfaces 153, 171 may align when first master link ends 150 are coupled to second master link ends 170. Shoe 124 may further include a cleat 128 used for traction.

First and second master link ends 150, 170 may include first and second mating surfaces 152, 172, respectively, when the master link ends 150, 170 are coupled together. It is understood that the first mating surface 152 of first master link ends 150 is similar to features of the second mating surface 172 of second master link ends 170. Thus, discussion of one mating surface 152, 172 of either master link end 150, 170 is equally applicable to the other master link end 150, 170.

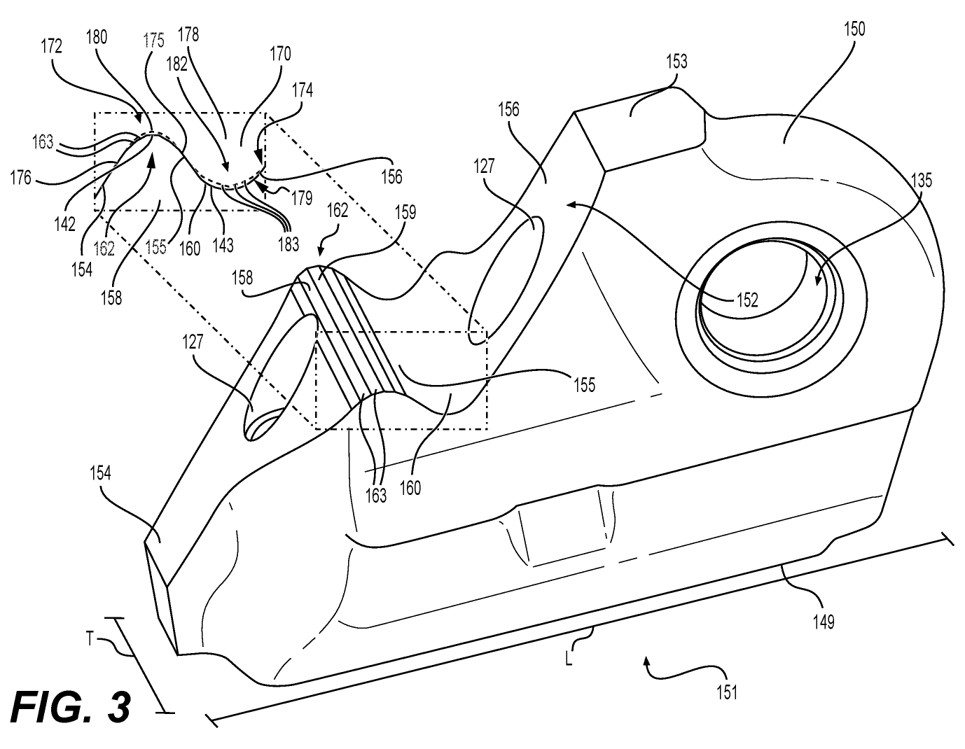

FIG. 3 depicts a portion of first master link 140A and, in particular, depicts a perspective side-view of first master link end 150, and a cutaway side-view of a portion of first master link end 150. As shown in FIG. 3, first master link end 150 includes a thickness (e.g., a minor dimension) T and a length (e.g., a major dimension) L. First master link end 150 may include a rail portion 151 and shoe surface 153. Rail portion 151 may be positioned on a first, bottom side of first master link end 150 and shoe surface 153 may be positioned on a second, top side of first master link ends 150, opposite to the first side.

First mating surface 152 of first master link end 150 may be mated (e.g., engaged) with corresponding second mating surface 172 of second master link 170 (as shown in FIG. 2 and dashed lines of side-view of FIG. 3). When mated, first mating surface 152 and second mating surface 172 may define one or more gaps 142, 143 therebetween. One or more gaps 142, 143 may be maintained during cycling or operation of chain 110.

Starting from a front or proximal end, first mating surface 152 may include a first ramp 154, a second ramp 155, and a third ramp 156. Each of ramps 154, 155, 156 may include a planar or generally planar surface. Second ramp 155 may include a length of approximately 8mm to approximately 13mm, for example, second ramp 155 may include a length of approximately 11mm. A tooth 158 of first mating surface 152 may be formed by and between first ramp 154 and second ramp 155. As will be discussed in further detail below, tooth 158 may include a convex crown 159 formed by a plurality of facets 162. The convex crown 159 may be sized to be a non-load bearing surface of master link end assembly 120. A concave surface 160 (e.g., a concave portion) of first mating surface 152 may be positioned between second ramp 155 and third ramp 156. Concave surface 160 may include a radius of curvature between approximately 8 mm and approximately 18 mm, and, in some examples, the radius of curvature may be approximately 13 mm.

First ramp 154 may extend from the proximal end of first mating surface 152 at an angle of between approximately twenty-five and seventy-five degrees, with respect to a bottom planar surface 149 of rail portion 151. For example, first ramp 154 may extend from the proximal end of first mating surface 152 at an angle of approximately fifty degrees. Second ramp 155 may extend from the tooth 158 at the end of the plurality of facets 162 to concave surface 160. Second ramp 155 may extend at an angle of between approximately twenty-five and seventy-five degrees, with respect to a bottom planar surface 149 of rail portion 151. For example, second ramp 155 may extend at an angle of approximately fifty degrees. Third ramp 156 may extend from concave surface 160 to a distal end of first mating surface 152. Third ramp 156 may extend at an angle of between approximately twenty-five and seventy-five degrees with respect to a bottom planar surface 149 of rail portion 151. For example, third ramp 156 may extend at an angle of approximately fifty degrees. When viewed from the viewing angle of FIG. 3, and in a direction from proximal to distal, first ramp 154 extends to form an incline, second ramp 155 extends to form a decline, and third ramp 156 extends to form an incline, all relative to the bottom planar surface 149 of rail portion 151.

As mentioned above, tooth 158 includes convex crown 159 formed by a plurality of facets 162. Each facet 163 of the plurality of facets 162 includes or is consists of a planar or flat surface, face, or side. The plurality of facets 162 adjoin one another to form convex crown 159 of tooth 158, and the convex crown 159 may form an approximate radius of curvature between approximately 10 mm and approximately 20 mm, and, in some examples, may include a radius of curvature of approximately 15 mm. The plurality of facets 162 may include between three and ten facets 163. For example, plurality of facets 162 may include five to seven facets 163. As noted, each facet 163 may be connected at a common or shared edge (e.g., common sides) to at least other one facet 163 of the plurality of facets 162. In other words, each facet 163 of plurality of facets 162 may adjoin or be connected in series with the other facets 163 of plurality of facets 162, with nothing in between. For example, a longitudinal side of each facet 163 may be immediately connected to a longitudinal side of another facet 163. The plurality of facets 162 may be configured such that the common edges of the plurality of facets 162 circumscribe or approximately circumscribe the radius of curvature or a circle. Explained differently, the common edges of the plurality of facets 162 may define or approximately define an arc of a circle. In some examples, instead of, or in addition to the common edges of the plurality of facets 162 circumscribing the radius of curvature or a circle, the width or at least a point (e.g., a lateral midpoint) of each facet 163 of the plurality of facets 162 may be tangent or approximately tangent to the radius of curvature or a circle.

Adjacent facets 163 of plurality of facets 162 may define an internal angle therebetween of approximately 130 degrees to approximately 180 degrees. For example, two adjacent facets 163 may define an approximately 160 degree angle. In some examples, each pair of adjacent facets 163 may define a same angle or approximately the same angle therebetween across all facets 163. Alternatively, only certain facets may share a common adjoining internal angle. In one or more examples, an angle between first ramp 154 and the proximal-most facet 163 connected to ramp 154 (e.g., the second end of first ramp 154) and an angle between second ramp 155 and the distal-most facet 163 connected to second ramp 155 (e.g., the first end of second ramp 155) may be a greater angle than the angle between pairs of adjacent facets 163 of plurality of facets 162. For example, the angle between second ramp 155 and connected facet 163 and between first ramp 154 and connected facet 163 may be approximately 170 degrees.

According to some aspects of the present disclosure, as discussed above, the internal angle between each adjacent facets 163 of plurality of facets 162 may define a same or approximately the same internal angle. The internal angle of each adjacent facets 163 may be dependent on the number of facets 163 of plurality of facets 162. For example, where the plurality of facets 162 includes three facets 163, the internal angle between each adjacent facets 163 may be approximately 130 degrees. In other example, where the plurality of facet 162 includes five facets 163, the internal angle between each adjacent facets 163 may be approximately 160 degrees. Further, where the plurality of facet 162 includes ten facets 163, the internal angle between each adjacent facets 163 may be approximately 175 degrees. It should be understood that increasing the number of facets may cause the internal angle because adjacent facets 163 to approach approximately 180 degrees.

Each facet may have a longitudinal axis, a longitudinal length, and a width or lateral dimension that is normal to the longitudinal axis. The width (e.g., a lateral dimension) of each facet 163 of plurality of facets 162 may be between approximate 3 mm and approximately 7 mm, and, in some examples, the width of each facet 163 is approximately 5 mm. According to some aspects of the present disclosure, each facet 163 may include the same width or approximately the same width as each other facet 163 of plurality of facets 162. According to other aspects of the present disclosure, the facet 163 connected to first ramp 154 and the facet 163 connected to second ramp 155 may include a greater width than the remaining facets 163 of plurality of facets 162.

A length of each facet 163 of plurality of facets 162 may extend an entirety of the thickness T of the first mating surface 152 and/or first master link end 150. In some examples, the length of each facet 163 may extend from a first longitudinal side of first mating surface 152 to a second longitudinal side of first mating surface 152, positioned opposite to the first longitudinal side.

Comparing tooth 158 to concave surface 160, surface 160 may include a continuous curve (e.g., a continuous concave surface with no facets 163) or a substantially continuous curve, whereas the convex crown 159 of tooth 158 includes the plurality of planar surfaces (e.g., facets 163). The continuous curve of concave surface 160 may extend from second ramp 155 (e.g., the second end of second ramp 155) to third ramp 156 (e.g., the first end of third ramp 156).

Still referring to FIG. 3, first master link end 150 may include one or more fastener holes 127 each configured to receive one of threaded fasteners 126. Each fastener hole 127 may be a blind hole, for example. One or more fastener holes 127 may include an opening at first mating surface 152. For example, as shown in FIG. 3, first master link end 150 may include two fastener holes 127. One of two fastener holes 127 may include a first opening through first ramp 154 and/or plurality of facets 162, and the other of the two fastener holes 127 may include a first opening through concave surface 160 and/or third ramp 156. An interior surface of fastener holes 127 may include threading compatible with the threading of threaded fasteners 126.

As discussed above and best shown in the cut-away sided view of FIG. 3, first master link end 150 may be mated with second master link end 170. As discussed above, first mating surface 152 of first master link ends 150 is similar to features of the second mating surface 172 of second master link ends 170. For example, second mating surface may include a non-faceted, continuous (e.g., or substantially continuous) concave surface 180 and a faceted tooth 158 including a plurality of facets 182 (including individual facets 183) forming a convex crown 179. Moreover, second mating surface 172 may include a first ramp 174, a second ramp 175, and a third ramp 176 each of which being similar to respective ramps 154, 155, 156 of first mating surface 152. When mated, faceted tooth 158 of first mating surface 152 may be received within the non-faceted concave surface 180 of second mating surface 172, and define first gap 142 between plurality of facets 162 and concave surface 180. Further, the faceted tooth 178 of second mating surface 172 may be received within concave surface 160 of first mating surface 152 and define a second gap 143 between facets 183 of plurality of facets 162 and concave surface 160. When engaged link ends 150, 170 are mated, a central (middle) facet 163, 183 of plurality of facets 162, 182 and the concave surface 160, 180 may define a distance between approximately 0.5 mm and approximately 2.5 mm, for example, the distance may be approximately 1.5 mm. When mated master link ends 150, 170 are used in connection with operation of machine 100, gaps 142, 143 may be maintained during use, preventing or limiting transfer of force from plurality of facets 162, 182 and concave surfaces 160, 180, respectively. Instead, transfer of force may occur between the ramps of first and second mating surfaces 152, 172.

The present disclosure includes a method 300 for manufacturing a master link end (e.g., master link ends 150, 170) of a master link assembly (e.g., assembly 120). Method 300 includes a step 302 of forging and/or casting an approximate or rough shape of a master link end 150, 170. In an example, when manufacturing first master link end 150, the approximate shape of the master link end 150 may include approximate or rough shapes of one or more of bore 135, rail portion 151, mating surface 152, shoe surface 153, and fastener holes 127, and combinations or subsets thereof. After step 302, the cast or forged master link end may include extra material, rough edges, metal shavings, incorrect dimensions or other defects (collectively “defects”) that may remain. Defects may be removed through machining via a grinder, a 4-axis milling machine, a 5-axis milling machine, and other similar devices used by those skilled in the art.

Method 300 may include a step 304 of heat treating the master link end 150, 170. In the example using first master link end 150, after performing step 302 first master link end 150 may be heat treated. Method 300 may include performing step 304 after any of the steps (e.g., step 302, 306, 308) of method 300. Heat treatment may increase the tensile strength and reduce brittleness of first master link end 150. In some examples, after step 304, method 300 may further include a step of initially machining the master link end. In the example with first master link end 150, when manufacturing first master link end 150, one or more of bore 135, rail portion 151, and shoe surface 153, and combinations or subsets thereof may be machined to fix defects of the respective feature. A grinder and/or 4-axis milling machine may be used to perform the initial machining step.

Method 300 may further include a step 306 of machining one or more features of the master link end 150, 170. In the example using first master link end 150, bore 135 and fastener holes 127 may be machined or further machined to remove or fix remaining defects. Step 306 may be performed via a grinder, a 4-axis milling machine, a 5-axis milling machine, and other similar devices. In some examples, a 4-axis milling machine is used to perform step 306, the 4-axis milling machine may utilize one fixture for machining both bore 135 and fastener holes 127. Alternatively, the 4-axis milling machine may utilize one fixture for machining bore 135 and another fixture for manufacturing fastener holes 127.

Method 300 may include a step 308 of machining one or more features of a mating surface 152, 172 of a master link end 150, 170, including facets 163, 183 of plurality of facets 162, 182. The mating surface may include the first ramp 154, second ramp 155, a third ramp 156, and a tooth 158. Step 308 may further include forming a convex crown 159 of the tooth 158. The convex crown 159 of the tooth may be formed by the plurality of facets 162. In the example with first master link end 150, features of first mating surface 152 may be machined to remove or fix remaining defects. During step 308, the convex crown 159 of tooth 158 (e.g. plurality of facets 162), first ramp 154, second ramp 155, and third ramp 156 may be machined. Step 308 may be performed with a grinder or 4-axis milling machine. In some examples, a 4-axis milling machine is used to perform step 308 and the 4-axis milling machine may utilize a different fixture of machining each facet 163 of plurality of facets 162.

After any of steps 304, 306, 308, method 300 may include a step of machining a concave surface 160 of the mating surface 152, 172 of the master link end 150, 170. The step of machining the concave surface 160 of the mating surface 152 may also be done, for example, with a 4-axis milling machine. For example, after heat treating first master link end 150 in step 306, concave surface 160 may be machined via the 4-axis milling machine.

### INDUSTRIAL APPLICABILITY

Master link assembly 120, as described herein, may be included in any machine having a chain for conveying mechanical force. In particular, master link assembly 120 may be used to couple a first end of the chain to a second end of the chain, opposite to the first end such that the chain is continuous. The disclosed master link assembly 120 and related methods may reduce manufacturing costs and time associated with manufacturing master link ends of a master link assembly.

The present disclosure helps to avoid machining costs, time, and difficulty by avoiding the use of unique and capital-intensive equipment such as creep-feed grinders and/or a 5-axis milling machines. In particular, the machining of the convex crown 159 of tooth 158 may be difficult if formed of a continuous curve, and may require such capital-intensive equipment, more machining time, more alignment time, more floor space, and more personnel training. As provided herein, forming the convex crown 159 of tooth 158 with a plurality of facets 162 (and thus not a continuous curve) may be machined by more standard equipment, such as a 4-axis milling machine. Further, the present disclosure recognizes that concave surface 160 (e.g., a concave curve) of the mating surface 152, 172 does not require such capital-intensive equipment, and thus does not require the facets 163.

The faceted convex crown 159 of the present disclosure also helps to minimize stress concentrations by reducing geometric irregularities, such as substantial corners. Further, the mating surfaces 152, 172 of master link ends 150, 170 may assist in load bearing when link ends 150, 170 are pulled in opposite directions. For example, the planar surface and length of the second ramps 155, 175 and/or the continuity of concave surfaces 160, 180 may assist in load bearing and stress reduction.

It will be apparent to those skilled in the art that various modifications and variations can be made to the disclosed assembly without departing from the scope of the disclosure. Other embodiments of the assembly will be apparent to those skilled in the art from consideration of the specification and practice of the assembly disclosed herein. It is intended that the specification and examples be considered as exemplary only, with a true scope of the disclosure being indicated by the following claims and their equivalents.

What is claimed is:

1. A master link end of a master link assembly, comprising:
a length and a thickness; and
a mating surface including a first ramp, a second ramp, a third ramp and a tooth formed by and between the first ramp and the second ramp, wherein the mating surface includes a concave surface between the second ramp and the third ramp;
wherein the tooth includes a convex crown formed by a plurality of facets;
wherein each facet of the plurality of facets shares a common edge with one or more facets of the plurality of facets;
wherein the common edges define or approximately define an arc of a circle.

2. The master link end of claim 1, wherein a length of each facet of the plurality of facets extends an entirety of the thickness of the master link end.

3. The master link end of claim 1, wherein the concave surface is formed of a substantially continuous curve without facets.

4. The master link end of claim 3, wherein the convex crown is sized to be a non-load bearing surface of the master link assembly.

5. The master link end of claim 1, wherein the plurality of facets includes between approximately 3 and 10 facets.

6. The master link end of claim 1, wherein an internal angle between adjacent facets of the plurality of facets is approximately 130 degrees to approximately 180 degrees.

7. The master link end of claim 1, wherein the convex crown includes an approximate radius of curvature between approximately 10 mm and approximately 20 mm.

8. The master link end of claim 1, wherein each facet of the plurality of facets includes a width, wherein the width of each facet of the plurality of facets is the same or approximately the same.

9. The master link end of claim 1, wherein each facet of the plurality of facets includes width, wherein at least two facets of the plurality of facets include a greater width than remaining facets of the plurality of facets.

10. The master link end of claim 1, wherein the master link end is a first master link end and the mating surface is a first mating surface, wherein the master link assembly further includes a second master link end including a second mating surface; wherein the second mating surface includes a concave surface; wherein the first master link end is configured to be mated with the second master link end; wherein, when mated, the tooth of the first mating surface is received within the concave surface of the second mating surface, and the plurality of facets of the tooth and the concave surface of the second mating surface define a gap therebetween.

11. The master link end of claim 10, wherein the gap is maintained during cycling of a chain including master link end.

12. The master link end of claim 10, wherein the concave surfaces of the first master link end and the second master link end are each formed by a continuous curve or substantially continuous curve.

13. A method of manufacturing a master link end of a master link assembly, comprising:
forging an approximate shape of a master link end;
machining a tooth formed by and between a first ramp and a second ramp, and machining a third ramp;
machining a plurality of facets to form a convex crown on the tooth, wherein a width of each facet of the plurality of facets is tangent or approximately tangent to a circle.

14. The method of claim 13, wherein the plurality of facets are formed with a 4-axis milling machine.

15. The method of claim 13, further comprising: machining a continuous concave surface without facets between the second ramp and the third ramp.

16. The method of claim 13, wherein the master link end includes a thickness, wherein a length of each facet of the plurality of facets extends an entirety of the thickness.

17. The method of claim 13, wherein a width of each facet of the plurality of facets is the same width.

18. A master link assembly, comprising:
a first master link end having a first mating surface;
a second master link end having a second mating surface; and
wherein, the first mating surface and second mating surface each include a tooth and a substantially continuous concave surface, the tooth including a convex crown formed by a plurality of facets;
wherein, each facet of the plurality of facets shares a common edge with one or more facets of the plurality of facets;
wherein, each facet of the plurality of facets includes a width, wherein the width of each facet of the plurality of facets is the same or approximately the same;
wherein, the first mating surface is configured to engage the second mating surface such that the tooth of the first mating surface is received within the substantially continuous concave surface of the second mating surface, and the tooth of the second mating surface is received within the substantially continuous concave surface of the first mating surface.

19. The master link assembly of claim 18, wherein an internal angle between adjacent facets of the plurality of facets is approximately 130 degrees to approximately 180 degrees.

20. The master link assembly of claim 18, wherein the plurality of facets is between 3 and 10 facets; wherein the common edges of the plurality of facets define or approximately define an arc of a circle.
